(19) United States
(12) Patent Application Publication
(10) Pub. No.: US 2010/0035610 A1
(43) Pub. Date: Feb. 11, 2010

(54) Method and Apparatus for Selecting a Best Cell During Inter-Radio Access Technology Transition

(75) Inventors: Mohit Narang, Escondido, CA (US); Mukesh K. Mittal, San Diego, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/188,996

(22) Filed: Aug. 8, 2008

(51) Int. Cl. H04Q 7/20

(52) U.S. Cl. 455/434

(57) ABSTRACT

An apparatus and method for selecting a best cell during transition between two radio access technologies comprising detecting a first signal from a selected cell, determining a first signal-to-noise ratio (SNR₁) measured from the first signal, attempting to acquire and to decode a second signal related to the first signal only one time if the SNR₁ is less than a first threshold, and continuing with the rest of the cell selection procedure if a second signal-to-noise ratio (SNR₂) measured from the second signal is greater than or equal to a second threshold. In one aspect, the first signal is a frequency correction channel (FCH) signal, and the second signal is a synchronization channel (SCH) signal. In one aspect, the selected cell is selected from a plurality of GSM cells based on at least one of receive signal strength indication (RSSI) criterion or base station identity code (BSIC) criterion.

### FIELD

This disclosure relates generally to apparatus and methods for selecting a best cell during inter-radio access technology transition.

### BACKGROUND

Mobile user equipments (UEs) typically transition from one wireless system to another wireless system depending on their mobility and the availability of coverage by the wireless systems. For example, transitions can occur between second generation (2G) and third generation (3G) wireless systems, between long term evolution (LTE) and 3G wireless systems or between LTE and Global System for Mobile Communications (GSM) wireless systems. Taking one example, 2G wireless systems typically provide basic digital voice and low rate data services to user equipment (UE) over a broad coverage area. That is, the 2G wireless systems typically have ubiquitous coverage. Broad coverage area is implemented using a plurality of cells, each with an access node (e.g. base station) to provide a wireless access connection between a UE, which is mobile within the coverage area, and the wireless communication system. The wireless access connection may employ space division multiple access (SDMA), frequency division multiple access (FDMA), time division multiple access (TDMA), code division multiple access (CDMA) and/or orthogonal frequency division multiple access (OFDMA) to allow a plurality of UEs to access the wireless communication system. In one example, the 2G wireless system is based on Global System for Mobile Communications (GSM)/General Packet Radio Service (GPRS)/Enhanced Data Rates for GSM Evolution (EDGE) while the 3G wireless system is based on Universal Mobile Telecommunication System (UMTS).

Many wireless communications systems are upgrading their infrastructure to provide enhanced communication services, such as high rate data services and Internet protocol (IP) packet transport services to mobile UEs. These enhanced communication services are typically provided by 3G wireless systems. In many cases, the 3G wireless systems are implemented only in portions of the broad coverage area provided by 2G wireless systems. That is, in many cases 3G wireless systems do not provide ubiquitous coverage. 3G coverage areas are typically situated in high density population areas, such as the centers of urban areas, airports, shopping centers, business parks, etc. In this case, 3G coverage areas appear as islands of coverage within the broader 2G coverage areas. This diversity of coverage areas introduces the necessity of transitioning the wireless access connection of the mobile UE between the 2G coverage area and 3G coverage area. Although the example of transitioning between the 2G coverage area and 3G coverage area is discussed here, the UE may transition between any coverage areas of any radio access technologies employed by any wireless systems, including but not limited to, UMTS (universal mobile telecommunication system), GSM (Global System for Mobile communications), GSM/GPRS (General Packet Radio Service/EDGE (Enhanced Data Rates for GSM Evolution), LTE (long term evolution), IS-95 (interim standard 95), CDMA2000, EVDO (evolution data optimized) or UMB (ultra mobile broadband), etc.

Typically, to transition from 3G to 2G, the received signal strength (RSSI) of the various candidates of 2G cells are measured. But a 2G cell may be selected based on the RSSI during transmission of the frequency channel (FCH) and synchronization channel (SCH) without consideration of the overall signal-to-noise ratio (SNR) due to interference from other 2G cells. Thus, the selected 2G cell may not have the best signal quality.

### SUMMARY

Disclosed is an apparatus and method for selecting the best cell during an inter-radio access technology (IRAT) transition or, in particular, for selecting the best GSM cell during UMTS compressed mode. According to one aspect, a method for selecting a best GSM cell during UMTS compressed mode comprising detecting a frequency correction channel (FCH) signal from a selected GSM cell; determining a signal-to-noise ratio of the FCH signal (FCH SNR); attempting to acquire and to decode a synchronization channel (SCH) signal related to the FCH signal only one time if the FCH SNR is less than a first threshold; and continuing with the rest of the GSM cell selection procedure if a signal-to-noise ratio of the SCH signal (SCH SNR) is greater than or equal to a second threshold.

According to another aspect, a method for selecting a best cell during transition between a first radio access technology and a second radio access technology, the method comprising detecting a first signal from a selected cell; determining a first signal-to-noise ratio (SNR₁) measured from the first signal; attempting to acquire and to decode a second signal related to the first signal only one time if the SNR₁ is less than a first threshold (TH₁ₛₜ); and continuing with the rest of the cell selection procedure if a second signal-to-noise ratio (SNR₂) measured from the second signal is greater than or equal to a second threshold (TH_{2nd}).

According to another aspect, a user equipment comprising a processor and a memory, the memory containing program code executable by the processor for performing the following: detecting a first signal from a selected cell; determining a first signal-to-noise ratio (SNR₁) measured from the first signal; attempting to acquire and to decode a second signal related to the first signal only one time if the SNR₁ is less than a first threshold (TH₁ₛₜ); and continuing with the rest of the cell selection procedure if a second signal-to-noise ratio (SNR₂) measured from the second signal is greater than or equal to a second threshold (TH_{2nd}).

According to another aspect, a computer program product, comprising: a computer-readable medium including program codes stored thereon, comprising: program codes for detecting a first signal from a selected cell; program codes for determining a first signal-to-noise ratio (SNR₁) measured from the first signal; program codes for attempting to acquire and to decode a second signal related to the first signal only one time if the SNR₁ is less than a first threshold (TH₁ₛₜ); and program codes for continuing with the rest of the cell selection procedure if a second signal-to-noise ratio (SNR₂) measured from the second signal is greater than or equal to a second threshold (TH_{2nd}).

Advantages of the present disclosure include a faster handover from a 3G cell to a 2G cell, in particular, from a UMTS cell to a best GSM cell. The present disclosure includes the advantage of reducing the 3G compressed mode duration and increasing the reliability of 3G compressed mode by accounting for 2G signal quality (e.g., measuring the frequency channel (FCH) and synchronization channel (SCH) signal-to-noise ratios) in selecting the best 2G cell. As a consequence, for example, the transition time from 3G to 2G coverage is minimized with increased reliability and overall user satisfaction.

It is understood that other aspects will become readily apparent to those skilled in the art from the following detailed description, wherein it is shown and described various aspects by way of illustration. The drawings and detailed description are to be regarded as illustrative in nature and not as restrictive.

### BRIEF DESCRIPTION OF THE DRAWINGS

FIG. 1 is a block diagram illustrating an example wireless system.

FIG. 2 shows an example of the user equipment (UE) approaching a coverage area A with access nodes A₁, A₂, A₃, A₄ and within the edge of another coverage area B with access nodes B₁ and B₂.

FIG. 3 illustrates an example flow diagram for the process for selecting the best GSM cell during UMTS compressed mode.

FIG. 4 illustrates an example flow diagram for the process for selecting the best cell during an inter-radio access technology (IRAT) transition.

FIG. 5 illustrates an example of a UMTS timeline showing transmission gaps for UMTS compressed mode and various related timeline parameters relating to FIG. 3.

FIG. 6 illustrates an example of a device comprising a processor in communication with a memory for executing the processes for selecting the best cell during an inter-radio access technology (IRAT) transition or, in particular, for selecting the best GSM cell during UMTS compressed mode.

FIG. 7 illustrates an example of a device suitable for selecting the best cell during an inter-radio access technology (IRAT) transition or, in particular, for selecting the best GSM cell during UMTS compressed mode.

### DETAILED DESCRIPTION

The detailed description set forth below in connection with the appended drawings is intended as a description of various aspects of the present disclosure and is not intended to represent the only aspects in which the present disclosure may be practiced. Each aspect described in this disclosure is provided merely as an example or illustration of the present disclosure, and should not necessarily be construed as preferred or advantageous over other aspects. The detailed description includes specific details for the purpose of providing a thorough understanding of the present disclosure. However, it will be apparent to those skilled in the art that the present disclosure may be practiced without these specific details. In some instances, well-known structures and devices are shown in block diagram form in order to avoid obscuring the concepts of the present disclosure. Acronyms and other descriptive terminology may be used merely for convenience and clarity and are not intended to limit the scope of the disclosure.

While for purposes of simplicity of explanation, the methodologies are shown and described as a series of acts, it is to be understood and appreciated that the methodologies are not limited by the order of acts, as some acts may, in accordance with one or more aspects, occur in different orders and/or concurrently with other acts from that shown and described herein. For example, those skilled in the art will understand and appreciate that a methodology could alternatively be represented as a series of interrelated states or events, such as in a flow diagram. Moreover, not all illustrated acts may be required to implement a methodology in accordance with one or more aspects.

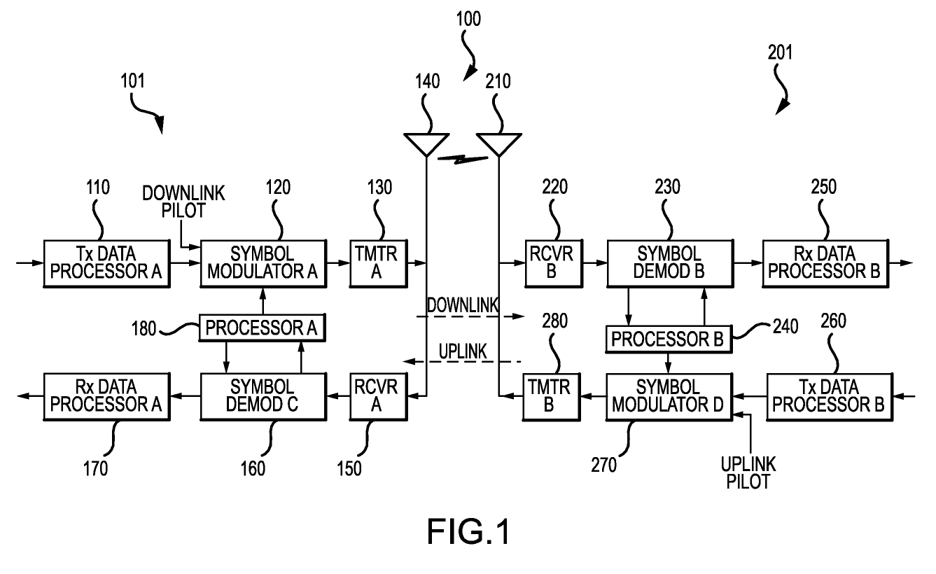

FIG. 1 is a block diagram illustrating an example access node/UE system 100. One skilled in the art would understand that the example access node/UE system 100 illustrated in FIG. 1 may be implemented in an FDMA environment, an OFDMA environment, a CDMA environment, a WCDMA environment, a TDMA environment, a SDMA environment or any other suitable wireless environment.

The access node/UE system 100 includes an access node 101 (a.k.a. base station) and a user equipment or UE 201 (a.k.a. wireless communication device). In the downlink leg, the access node 101 (a.k.a. base station) includes a transmit (TX) data processor A 110 that accepts, formats, codes, interleaves and modulates (or symbol maps) traffic data and provides modulation symbols (a.k.a. data symbols). The TX data processor A 110 is in communication with a symbol modulator A 120. The symbol modulator A 120 accepts and processes the data symbols and downlink pilot symbols and provides a stream of symbols. In one aspect, symbol modulator A 120 is in communication with processor A 180 which provides configuration information. Symbol modulator A 120 is in communication with a transmitter unit (TMTR) A 130. The symbol modulator A 120 multiplexes the data symbols and downlink pilot symbols and provides them to the transmitter unit A 130.

Each symbol to be transmitted may be a data symbol, a downlink pilot symbol or a signal value of zero. The downlink pilot symbols may be sent continuously in each symbol period. In one aspect, the downlink pilot symbols are frequency division multiplexed (FDM). In another aspect, the downlink pilot symbols are orthogonal frequency division multiplexed (OFDM). In yet another aspect, the downlink pilot symbols are code division multiplexed (CDM). In one aspect, the transmitter unit A 130 receives and converts the stream of symbols into one or more analog signals and further conditions, for example, amplifies, filters and/or frequency upconverts the analog signals, to generate an analog downlink signal suitable for wireless transmission. The analog downlink signal is then transmitted through antenna 140.

In the downlink leg, the UE 201 includes antenna 210 for receiving the analog downlink signal and inputting the analog downlink signal to a receiver unit (RCVR) B 220. The receiver unit B 220 conditions, for example, filters, amplifies, and frequency downconverts the analog downlink signal to a first “conditioned” signal. The first “conditioned” signal is then sampled. The receiver unit B 220 is in communication with a symbol demodulator B 230. The symbol demodulator B 230 demodulates the first “conditioned” and “sampled” signal (a.k.a. data symbols) outputted from the receiver unit B 220. The symbol demodulator B 230 is in communication with a processor B 240. Processor B 240 receives downlink pilot symbols from symbol demodulator B 230 and performs channel estimation on the downlink pilot symbols. In one aspect, the channel estimation is the process of characterizing the current propagation environment. The symbol demodulator B 230 receives a frequency response estimate for the downlink leg from processor B 240. The symbol demodulator B 230 performs data demodulation on the data symbols to obtain data symbol estimates on the downlink path. The data symbol estimates on the downlink path are estimates of the data symbols that were transmitted. The symbol demodulator B 230 is also in communication with a RX data processor B 250.

The RX data processor B 250 receives the data symbol estimates on the downlink path from the symbol demodulator B 230 and, for example, demodulates (i.e., symbol demaps), interleaves and/or decodes the data symbol estimates on the downlink path to recover the traffic data. In one aspect, the processing by the symbol demodulator B 230 and the RX data processor B 250 is complementary to the processing by the symbol modulator A 120 and TX data processor A 110, respectively.

In the uplink leg, the UE 201 includes a TX data processor B 260. The TX data processor B 260 accepts and processes traffic data to output data symbols. The TX data processor B 260 is in communication with a symbol modulator D 270. The symbol modulator D 270 accepts and multiplexes the data symbols with uplink pilot symbols, performs modulation and provides a stream of symbols. In one aspect, symbol modulator D 270 is in communication with processor B 240 which provides configuration information. The symbol modulator D 270 is in communication with a transmitter unit B 280.

Each symbol to be transmitted may be a data symbol, an uplink pilot symbol or a signal value of zero. The uplink pilot symbols may be sent continuously in each symbol period. In one aspect, the uplink pilot symbols are frequency division multiplexed (FDM). In another aspect, the uplink pilot symbols are orthogonal frequency division multiplexed (OFDM). In yet another aspect, the uplink pilot symbols are code division multiplexed (CDM). The transmitter unit B 280 receives and converts the stream of symbols into one or more analog signals and further conditions, for example, amplifies, filters and/or frequency upconverts the analog signals, to generate an analog uplink signal suitable for wireless transmission. The analog uplink signal is then transmitted through antenna 210.

The analog uplink signal from UE 201 is received by antenna 140 and processed by a receiver unit A 150 to obtain samples. In one aspect, the receiver unit A 150 conditions, for example, filters, amplifies and frequency downconverts the analog uplink signal to a second “conditioned” signal. The second “conditioned” signal is then sampled. The receiver unit A 150 is in communication with a symbol demodulator C 160. The symbol demodulator C 160 performs data demodulation on the data symbols to obtain data symbol estimates on the uplink path and then provides the uplink pilot symbols and the data symbol estimates on the uplink path to the RX data processor A 170. The data symbol estimates on the uplink path are estimates of the data symbols that were transmitted. The RX data processor A 170 processes the data symbol estimates on the uplink path to recover the traffic data transmitted by the wireless communication device 201. The symbol demodulator C 160 is also in communication with processor A 180. Processor A 180 performs channel estimation for each active terminal transmitting on the uplink leg. Multiple terminals may transmit pilot symbols concurrently on the uplink leg on their respective assigned sets of pilot subbands where the pilot subband sets may be interlaced.

Processor A 180 and processor B 240 direct (i.e., control, coordinate or manage, etc.) operation at the access node 101 (a.k.a. base station) and at the UE 201, respectively. In one aspect, either or both processor A 180 and processor B 240 are associated with one or more memory units (not shown) for storing of program codes and/or data. In one aspect, either or both processor A 180 or processor B 240 or both perform computations to derive frequency and impulse response estimates for the uplink leg and downlink leg, respectively.

In one aspect, the access node/UE system 100 is a multiple-access system. For a multiple-access system (e.g., FDMA, OFDMA, CDMA, TDMA, SDMA, etc.), multiple terminals transmit concurrently on the uplink leg. For the multiple-access system, the pilot subbands may be shared among different terminals. Channel estimation techniques are used in cases where the pilot subbands for each terminal span the entire operating band (possibly except for the band edges). Such a pilot subband structure is desirable to obtain frequency diversity for each terminal.

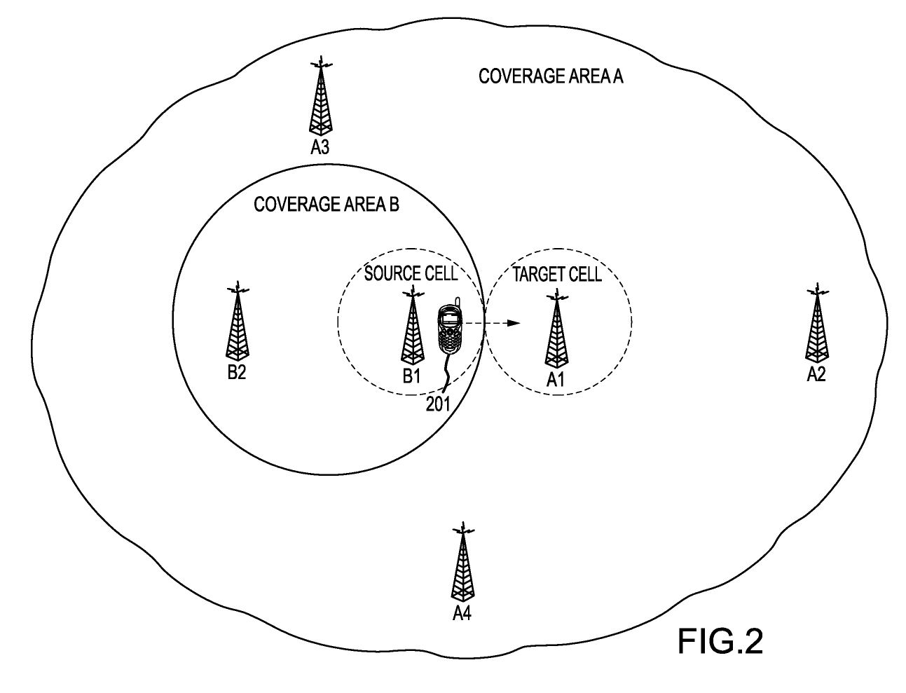

FIG. 2 shows an example of the user equipment (UE) approaching a coverage area A with access nodes A₁, A₂, A₃, A₄ and within the edge of another coverage area B with access nodes B₁ and B₂. As shown in FIG. 2, UE 201 is located within the source cell within coverage area B and approaching the target cell within coverage area A. Coverage area A employs radio access technology A while coverage area B employs radio access technology B. Wireless system A is associated with coverage area A, and wireless system B is associated with coverage area B. In one aspect, as the UE 201 approaches the target cell, a comparison is made to determine if the signal quality from the target cell (a.k.a. target cell signal quality) is higher than the signal quality from the source cell (a.k.a. source cell signal quality). If the signal quality from the target cell is higher, then a transition is made from the source cell to the target cell, i.e., an inter-radio access technology (IRAT) transition is triggered from the source cell to the target cell. In one aspect, the signal quality from the target cell must be higher than the signal quality from the source cell for a continuous X time interval before the transition is made. In one example, the X time interval is 5 seconds.

Transitioning the wireless access connection of the UE 201 between wireless systems A and B requires a finite amount of time to complete. For example, if UE 201 starts in the source cell within coverage area B (e.g., a 3G coverage area employing 3G radio access technology by a 3G wireless system) and moves towards the target cell within coverage area A (e.g., a 2G coverage area employing 2G radio access technology by a 2G wireless system), the UE 201 may reselect to wireless system A (e.g., 2G wireless system) and start collecting system information from the access nodes within coverage area A. This process may not be completed for some time, e.g., several seconds such as 3-5 seconds for some systems. During this wait period, signal quality may be compromised, and signals may even be dropped, resulting in user dissatisfaction.

One skilled in the art would understand that the scope and spirit of the present disclosure are not affected by other examples of radio access technologies employed by other wireless systems, including but not limited to, UMTS, WCDMA, GSM, GSM/GPRS/EDGE, LTE, IS-95, CDMA2000, EVDO or UMB, etc.

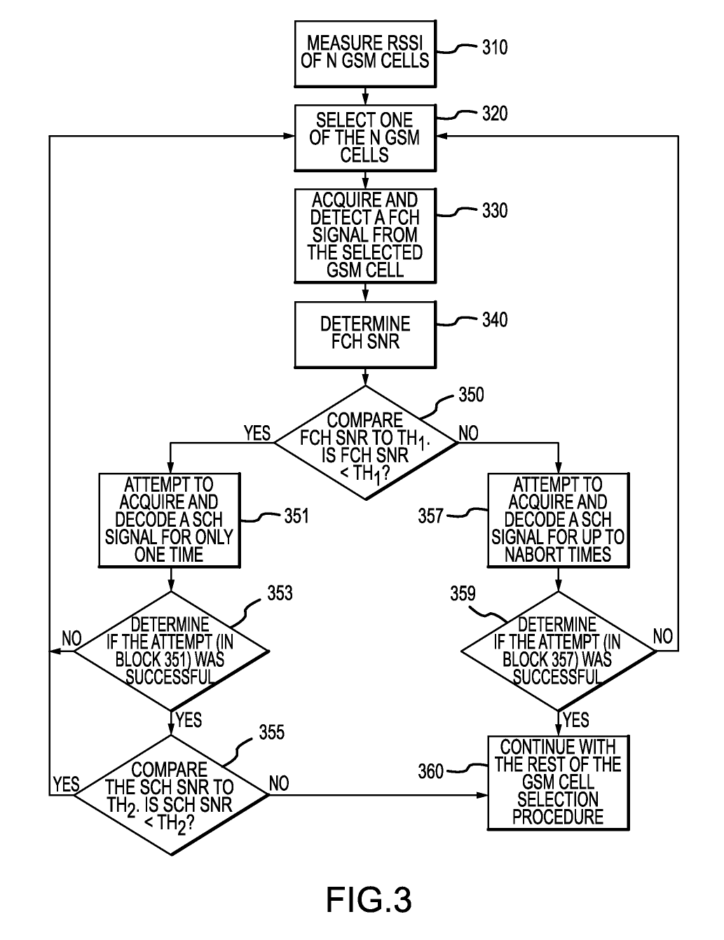

FIG. 3 illustrates an example flow diagram for selecting the best GSM cell in a UMTS compressed mode. While operating in UMTS, a transmission gap can be inserted into the UMTS frame during transmission of data between a mobile user equipment (UE) and its access node. To obtain a transmission gap, the data portion of the UMTS frame is truncated. However, the integrity of the data is preserved through various methods (such as an increase in data rate with a decrease in spreading factor) known to one skilled in the art. Having a transmission gap allows the UE to measure receive signal strength indication (RSSI) from neighboring GSM cells during the gap. The purpose of measuring RSSI from neighboring GSM cells is to evaluate the best GSM cell for a handover from the current UMTS cell to a new selected GSM cell. RSSI measurements are taken of the frequency correction channel (FCH) and also separately of the synchronization channel (SCH) to obtain their signal-to-noise ratios (FCH SNR and SCH SNR) respectively. Currently, the most common form of UMTS uses WCDMA (wideband code division multiple access) as the underlying air interface between the mobile user equipment (UE) and the access node. Therefore, if WCDMA is used as the underlying air interface, a transmission gap is inserted into the WCDMA frame.

In block 310, measure the receive signal strength indication (RSSI) of N GSM cells where N stands for the number of GSM cells available for reception. Next, in block 320, select a first of the N GSM cells for evaluation. In one aspect the selection is based on the value of the RSSI. In another aspect, the selection is based on the base station identity code (BSIC) associated with the GSM cell. In yet another aspect, the selection is arbitrary. In block 330, acquire and detect a frequency correction channel (FCH) signal from the selected GSM cell. In block 340, determine the FCH signal-to-noise ratio (SNR). In one aspect, the FCH SNR is determined by a) obtaining a power measurement when the FCH signal is active, b) obtaining a power measurement when the FCH signal is off, and c) taking the ratio of the two power measurements. The power measurement is taken at the channel assigned to the FCH signal. In block 350, compare the FCH SNR to a first threshold TH₁. If FCH SNR<TH₁, then proceed to block 351. Otherwise, proceed to block 357. In one example, TH₁ equals to 5 dB. One skilled in the art would understand that the value of TH₁ can be chosen based on the particular application, system design and operator choice without affecting the scope or spirit of the present disclosure.

In block 351, attempt to acquire and decode a synchronization channel (SCH) signal associated with the FCH signal for only one time. In block 353, determine if the attempt to acquire and decode the SCH signal was successful or not. If successful, proceed to block 355. If not successful, return to block 320 and select a second of the N GSM cells for evaluation. In block 355, compare the SCH SNR to a second threshold TH₂. If SCH SNR<TH₂, then return to block 320 and select the second of the N GSM cells for evaluation. In one aspect, the SCH SNR is determined by a) obtaining a power measurement when the SCH signal is active, b) obtaining a power measurement when the SCH signal is off, and c) taking the ratio of the two power measurements. The power measurement is taken at the channel assigned to the SCH signal. One skilled in the art would understand that the value of TH₂ can be chosen based on the particular application, system design and operator choice without affecting the scope or spirit of the present disclosure.

As shown in FIG. 3, both a “no” result from block 353 and a “yes” result from block 355 cause a return to block 320 to select the second of the N GSM cells. If SCH SNR>TH₂ proceed to block 360 and to continue with the rest of the GSM cell selection procedure for the handover. One skilled in the art would understand that the process in block 360 includes any standard handover process, such as the handover process in GSM which is well known to one skilled in the art.

In block 357, attempt to acquire and decode the synchronization channel (SCH) up to NABORT times. In one example, NABORT is a programmable parameter specifying the maximum number of times acquisition and decoding of SCH should be attempted before aborting the procedure. In one example, the value of NABORT is 5. In block 359, determine if the acquisition and decoding of SCH was successful. If successful, proceed to block 360 and continue with the rest of the GSM cell selection procedure. If not successful, return to block 320 and select the second of the N GSM cells for evaluation.

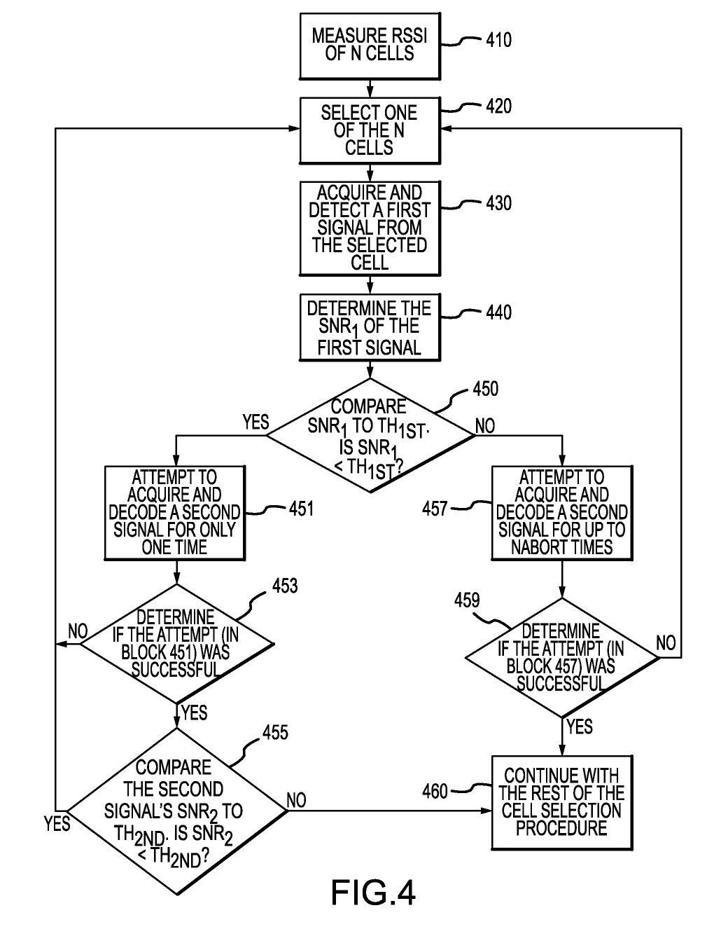

One skilled in the art would understand that the example illustrated in FIG. 3 is not limited to the application of only GSM cells, FCH signals and SCH signals. For example, FIG. 4 illustrates an example flow diagram for selecting the best cell during an inter-radio access technology (IRAT) transition. In block 410, measure the receive signal strength indication (RSSI) of N cells where N stands for the number of cells available for reception. Next, in block 420, select a first of the N cells for evaluation. In one aspect, the selection is based on one of the following: value of the RSSI and/or base station identification number associated with the cell. In block 430, acquire and detect a first signal from the selected cell. In one example, the first signal is used for frequency acquisition. In block 440, determine the signal-to-noise ratio (SNR₁) of the first signal. In one aspect, the SNR₁ is determined by a) obtaining a power measurement when the first signal is active, b) obtaining a power measurement when the first signal is off, and c) taking the ratio of the two power measurements. The power measurement is taken at the channel assigned to the first signal. In block 450, compare SNR₁ to a first threshold TH₁ₛₜ. If SNR₁<TH₁ₛₜ, then proceed to block 451. Otherwise, proceed to block 457. In one example, TH₁ₛₜ equals to 5 dB. One skilled in the art would understand that the value of TH₁ₛₜ can be chosen based on the particular application, system design and operator choice without affecting the scope or spirit of the present disclosure.

In block 451, attempt to acquire and decode a second signal for only one time. In one example, the second signal is used for time acquisition. In one example, the second signal is the same as the first signal. In block 453, determine if the attempt to acquire and decode the second signal was successful or not. If successful, proceed to block 455. If not successful, return to block 420 and select a second of the N cells for evaluation. In block 455, compare the second signal's signal-to noise ratio (SNR₂) to a second threshold TH_{2nd}. If SNR₂<TH_{2nd}, then return to block 420 and select the second of the N cells for evaluation. If SNR₂≧TH_{2nd} proceed to block 460 and to continue with the rest of the cell selection procedure. In one aspect, the SNR₂ is determined by a) obtaining a power measurement when the second signal is active, b) obtaining a power measurement when the second signal is off, and c) taking the ratio of the two power measurements. The power measurement is taken at the channel assigned to the second signal. One skilled in the art would understand that the value of TH_{2nd} can be chosen based on the particular application, system design and operator choice without affecting the scope or spirit of the present disclosure.

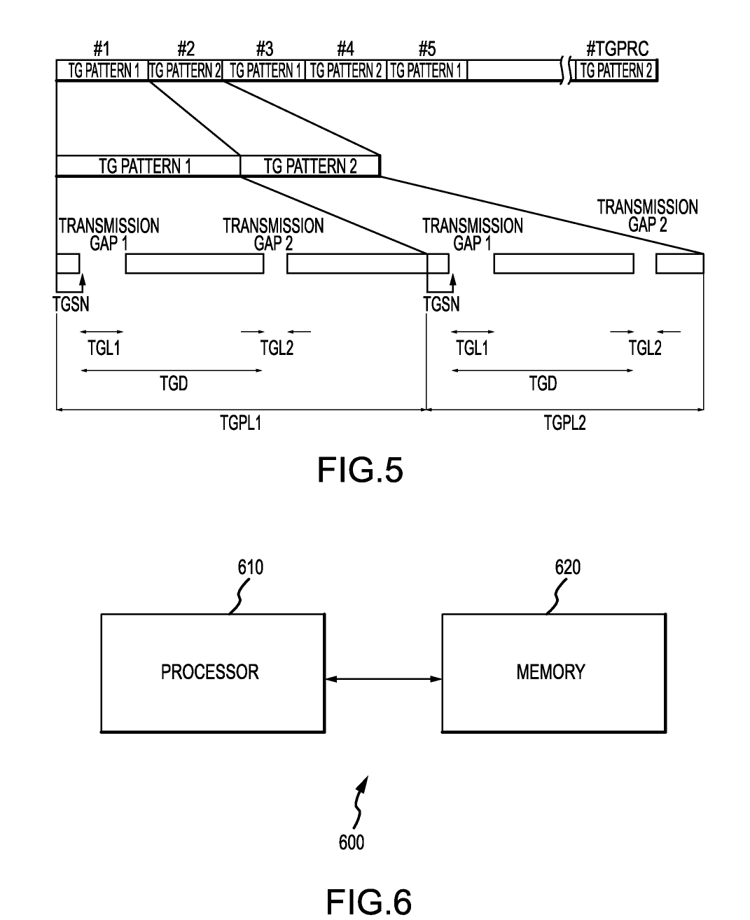

In block 457, attempt to acquire and decode the second signal up to NABORT times. In one example, NABORT is a programmable parameter specifying the maximum number of times acquisition and decoding of the second signal should be attempted before aborting the procedure. In one example, the value of NABORT is 5. In block 459, determine if the acquisition and decoding of the second signal was successful. If successful, proceed to block 460 and continue with the rest of the cell selection procedure. If not successful, return to block 420 and select the second of the N cells for evaluation. FIG. 5 illustrates an example of a UMTS timeline showing transmission gaps for UMTS compressed mode and various related timeline parameters relating to FIG. 3. During the transmission gaps (i.e., transmission gap 1, transmission gap 2, etc.) shown in FIG. 5, RSSI measurements (block 310 of FIG. 3) of the N GSM cells are taken. Table 1 below illustrates the timing parameters shown in FIG. 5.

TABLE 1

| | | | | | | | | | | DL |
|---|---|---|---|---|---|---|---|---|---|---|
| | | | | | | | | | CM | Frame |
| TGMP | TGPRC | TGCFN | TGSN | TGL1 | TGL2 | TGD | TGPL1 | TGPL2 | Method | Type |
| 2 | 0 | X | 4 | 7 | 7 | 270 | 8 | 8 | SF/2 | A |
| 3 | 0 | X + 2 | 4 | 7 | 7 | 270 | 8 | 8 | SF/2 | A |
| 4 | 0 | X + 6 | 4 | 7 | 7 | 270 | 8 | 8 | SF/2 | A |

1. TGMP: Transmission Gap Measurement Purpose states the type of measurement to obtain.
2. TGPRC: Transmission Gap Pattern Repetition Count indicates the number of transmission gap (TG) patterns within the TG pattern sequence.
3. TGCFN: Transmission Gap Connection Frame Number indicates the connection frame number (CFN) of the first radio frame of the first pattern within the TG pattern sequence.
4. TGSN: Transmission Gap Starting Slot Number indicates the slot number of the first TG slot within the first radio frame of the TG pattern.
5. TGL: Transmission Gap Length indicates the duration of the transmission gap in number of slots.
6. TGD: Transmission Gap Start Distance indicates the duration between the starting slots of two consecutive transmission gaps within a TG pattern, expressed in number of slots
7. TGPL: Transmission Gap Pattern Length indicates the duration of the TG pattern expressed in number of frames.
8. CM: Compressed Mode Method is the method of achieving compressed mode. As listed in Table 1, SF/2 indicates the spreading factor is decreased by a factor of 2.
9. DL: Downlink Frame Type is the frame structure type for downlink compressed frames.
Type A listed in Table 1 is an example. Type A maximizes the transmission gap length.

A more detailed explanation of the timing parameters illustrated in FIG. 5 and Table 1 is found in 3rd Generation Partnership Project; Technical Specification Group Radio Access Network; Physical layer—Measurements (FDD) 3GPP TS 25.215 which is known to one skilled in the art.

One skilled in the art would understand that the flow diagrams, logical blocks and/or modules described herein may be implemented by various ways such as in hardware, firmware, software or a combination thereof. For example, for a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described therein, or a combination thereof. With software, the implementation may be through modules (e.g., procedures, functions, etc.) that perform the functions described therein. The software codes may be stored in memory units and executed by a processor unit. Additionally, the various illustrative flow diagrams, logical blocks and/or modules described herein may also be coded as computer-readable instructions carried on any computer-readable medium or computer program product known in the art.

In one example, the illustrative flow diagrams, logical blocks and/or modules described herein is implemented or performed with one or more processors. In one aspect, a processor is coupled with a memory which stores data, metadata, program instructions, etc. to be executed by the processor for implementing or performing the various flow diagrams, logical blocks and/or modules described herein. FIG. 6 illustrates an example of a device 600 comprising a processor 610 in communication with a memory 620 for executing the processes for selecting the best cell during an inter-radio access technology (IRAT) transition or, in particular, for selecting the best GSM cell during UMTS compressed mode. In one example, the device 600 is used to implement the algorithm illustrated in FIGS. 3 and 4. In one aspect, the memory 620 is located within the processor 610. In another aspect, the memory 620 is external to the processor 610.

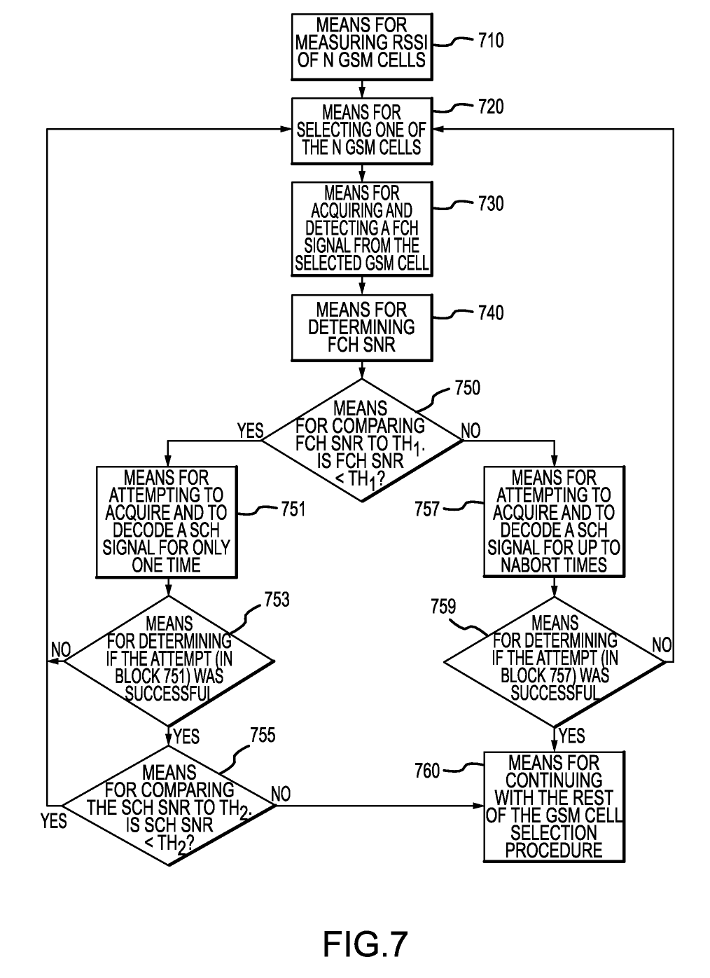

FIG. 7 illustrates an example of a device 700 suitable for selecting the best cell during an inter-radio access technology (IRAT) transition or, in particular, for selecting the best GSM cell during UMTS compressed mode. In one aspect, the device 700 is implemented by at least one processor comprising one or more modules configured to provide different aspects of selecting the best GSM cell during UMTS compressed mode as described herein in blocks 710, 720, 730, 740, 750, 751, 753, 755, 757, 759 and 760. For example, each module comprises hardware, firmware, software, or any combination thereof. In one aspect, the device 700 is also implemented by at least one memory in communication with the at least one processor.

The previous description of the disclosed aspects is provided to enable any person skilled in the art to make or use the present disclosure. Various modifications to these aspects will be readily apparent to those skilled in the art, and the generic principles defined herein may be applied to other aspects without departing from the spirit or scope of the disclosure.

1. A method for selecting a best GSM cell during UMTS compressed mode comprising:
detecting a frequency correction channel (FCH) signal from a selected GSM cell;
determining a signal-to-noise ratio of the FCH signal (FCH SNR);
attempting to acquire and to decode a synchronization channel (SCH) signal related to the FCH signal only one time if the FCH SNR is less than a first threshold; and
continuing with the rest of the GSM cell selection procedure if a signal-to-noise ratio of the SCH signal (SCH SNR) is greater than or equal to a second threshold.

2. The method of claim 1 further comprising selecting the selected GSM cell from a plurality of GSM cells based on a receive signal strength indication (RSSI) criterion.

3. The method of claim 1 further comprising selecting the selected GSM cell from a plurality of GSM cells based on a base station identity code (BSIC) criterion.

4. The method of claim 1 further comprising selecting the selected GSM cell from a plurality of GSM cells based on a receive signal strength indication (RSSI) criterion and a base station identity code (BSIC) criterion.

5. The method of claim 1 further comprising measuring receive signal strength indication (RSSI) on a plurality of GSM cells; and selecting the selected GSM cell from the plurality of GSM cells based on the receive signal strength indication (RSSI).

6. The method of claim 5 wherein the first threshold and the second threshold are power measurement values.

7. The method of claim 6 wherein the first threshold is 5 dB.

8. A method for selecting a best cell during transition between a first radio access technology and a second radio access technology, the method comprising:
detecting a first signal from a selected cell;
determining a first signal-to-noise ratio (SNR₁) measured from the first signal;
attempting to acquire and to decode a second signal related to the first signal only one time if the SNR₁ is less than a first threshold (TH₁ₛₜ); and
continuing with the rest of the cell selection procedure if a second signal-to-noise ratio (SNR₂) measured from the second signal is greater than or equal to a second threshold (TH_{2nd}).

9. The method of claim 8 wherein the first radio access technology is a 3G technology and the second radio access technology is a 2G technology.

10. A user equipment comprising a processor and a memory, the memory containing program code executable by the processor for performing the following:
detecting a first signal from a selected cell;
determining a first signal-to-noise ratio (SNR₁) measured from the first signal;
attempting to acquire and to decode a second signal related to the first signal only one time if the SNR₁ is less than a first threshold (TH₁ₛₜ); and
continuing with the rest of the cell selection procedure if a second signal-to-noise ratio (SNR₂) measured from the second signal is greater than or equal to a second threshold (TH_{2nd}).

11. The user equipment of claim 10 wherein the first signal is used for frequency acquisition and the second signal is used for time acquisition.

12. The user equipment of claim 11 wherein the first signal is the same as the second signal.

13. The user equipment of claim 10 wherein the first signal is a frequency correction channel (FCH) signal, and the second signal is a synchronization channel (SCH) signal.

14. The user equipment of claim 13 wherein the memory further comprising program code for selecting the selected cell from a plurality of GSM cells based on at least one of receive signal strength indication (RSSI) criterion or base station identity code (BSIC) criterion.

15. The user equipment of claim 14 wherein the first threshold and the second threshold are power measurement values.

16. The user equipment of claim 15 wherein the first threshold is 5 dB.

17. A computer program product, comprising: a computer-readable medium including program codes stored thereon, comprising:
program codes for detecting a first signal from a selected cell;
program codes for determining a first signal-to-noise ratio (SNR₁) measured from the first signal;
program codes for attempting to acquire and to decode a second signal related to the first signal only one time if the SNR₁ is less than a first threshold (TH₁ₛₜ); and
program codes for continuing with the rest of the cell selection procedure if a second signal-to-noise ratio (SNR₂) measured from the second signal is greater than or equal to a second threshold (TH_{2nd}).

18. The computer program product of claim 17 wherein the first signal is a frequency correction channel (FCH) signal, and the second signal is a synchronization channel (SCH) signal.

19. The computer program product of claim 18 further comprising program codes for selecting the selected cell from a plurality of GSM cells based on at least one of receive signal strength indication (RSSI) criterion or base station identity code (BSIC) criterion.

20. The computer program product of claim 19 further comprising program codes for measuring receive signal strength indication (RSSI) on the plurality of GSM cells.
